(19) United States
(12) Patent Application Publication
(10) Pub. No.: US 2005/0271461 A1
(43) Pub. Date: Dec. 8, 2005

(54) Full bleed DVD case insert sheet, and related method

(76) Inventor: Richard Mitchell Fry, Olney, MD (US)

Correspondence Address: Thomas P. Liniak;Liniak, Berenato & White, Suite 240, 6550 Rock Spring Drive, Bethesda, MD, 20817, US

(21) Appl. No.: 10/857,897

(22) Filed: Jun. 2, 2004

(51) Int. Cl. B42D 15/00

(52) U.S. Cl. 402/79

(57) ABSTRACT

A case insert printable sheet suitable for use in the production of a DVD insert is provided. The sheet has a peripheral edge and a defined pattern of reduced strength spaced inside the peripheral edge. The defined pattern has rectangular dimensions of about 7.25 inches by about 10.6875 inches to define an insert portion suitable for fitting an industry standard DVD case. The defined pattern is spaced apart from the peripheral edge to establish a margin portion between the defined pattern and the peripheral edge. The margin portion surrounds the insert portion and spaces the insert portion apart from the peripheral edge by a minimum distance of at least 0.5 inches. Preferably, the case insert printable sheet is United States standard legal size paper. A method for making the DVD insert is also provided.

### BACKGROUND OF THE INVENTION

1. Filed of the Invention

This invention relates to inserts suitable for use in digital video disc (“DVD”) cases, printable sheets for making the inserts, and to methods for making and using the inserts.

2. Background of the Invention

Digital Video Discs (or DVDs) are part of a new generation of optical disc storage technology that allows for the storage of a large volume of information in a compact medium. In many ways, DVD technology is superior to its videotape and compact disc (or “CD”) predecessors. DVDs are more durable than video tapes. DVDs can also hold more information than video tapes and compact discs, making DVDs more suitable for storage of both video and audio information. As a result, DVDs have gained wide and still growing acceptance in various industries, including, for example, the motion picture, video game, and computer software industries.

Due to the somewhat fragile nature of DVDs which are susceptible to scratching and breakage, it is standard industry practice to sell, transport, and store DVDs in protective cases. There are industry standard dimensions for DVD cases. Generally, a DVD case comprises front and rear faces measuring approximately 7.5 inches (190.5 mm)×approximately 5.25 inches (133.35 mm), and a spine measuring about 7.5 inches (190.5 mm)×approximately 9/16 inches (14.3 mm).

In order to identify the contents of the DVD inside the case (without opening the case), it also is industry practice to adorn the DVD protective case with an identification insert. The insert typically is made of a suitable printable media, such as a paper sheet or the like, onto which a layout comprising the identifying information and optionally decorations is printed.

The industry standard dimensions of a DVD insert are approximately 7.25 inches (184.15 mm)×approximately 10 11/16 inches (271.15 mm). These DVD insert dimensions are slightly smaller than those of standard letter size 8½ (215.9 mm)×11″ (279.4 mm) paper. To address this size difference, DVD insert manufacturing processes using standard letter size paper comprise a step of perforating the standard size paper to create a pattern corresponding to that of the industry standard size insert. Border portions of the standard letter size paper outside the pattern are detached and treated as waste. The amount of waste paper is relatively small in view of the close correspondence between the dimensions of standard paper and DVD inserts. As a consequence, the selection standard size paper is widely favored as the stock of choice for making DVD inserts.

The inventor has found that the close similarity between the dimensions of the standard size paper and DVD inserts creates problems in the above-described case insert manufacturing process. Regardless of the placement of the perforated borders of the DVD insert on the printable media, insufficient area is left outside the perforated border to allow for satisfactory bleeding of a printed image. Additionally, the small area outside the perforated border may be difficult to grip and tear efficiently along the perforation.

Bleeding is a process in which an image is printed in such a manner as to extend beyond the intended border or edge of the product insert, e.g., to extend into the waste portion of the paper stock. Vector-based art layout programs such as Adobe Illustrator would be a natural choice to produce the final artwork to print on printable media, e.g. sheet. However, when there is little or no bleed area to work with, even a user with advanced software is at a disadvantage. Without proper bleed area, the user is not able to easily move the image around the sheet and let it “set down” in the best position, effectively cropping the image for the most pleasing appearance. Instead, to create a professional appearance, the printed image must be aligned perfectly within the borders of the paper stock. Furthermore, without a bleed area the edges of the perforated insert can undesirably appear white, as if they were not printed all the way to the edge of the sheet.

Custom paper also has been used for printing DVD inserts. Custom paper typically has an identical size to that of an industry standard DVD insert. As a result, custom paper circumvents some manufacturing inefficiencies, e.g., tearing and disposing of border waste, encountered with standard letter size paper. However, custom paper suffers from the same problems concerning bleeding as standard letter size paper. The use of non-standard paper and uncommon paper sizes, such as A4, creates additional problems for a consumer trying to create his/her own personalized insert. Non-standard and uncommon size paper is not compatible with all printers, and sometimes requires special software to use. Further, irregular or “off-center” sheets (where the DVD insert is not centered on the sheet) require that care be taken not to insert the paper upside-down or sideways into a printer. Furthermore, the higher costs of custom and A4 paper compared to stock size paper may add an unnecessary expense to the manufacturing process.

Finally, many inkjet printers require a “gripper” margin at the bottom of the sheet of approximately ½″ (12.7 mm). When the gripper margin is taken into account on a smaller sheet such as A4 paper, the requisite margin pushes the die cut for the insert up to the top of the sheet, thereby negating or minimizing the bleed area at the top and resulting in a small discard piece that may be difficult to remove. On an 8½″×11″ sheet of paper, the gripper margin has a more severe impact, in that the margin results in an unprintable area at the bottom of the sheet of slightly less than ½″.

### SUMMARY OF THE INVENTION

It is therefore an object of the present invention to provide a case insert printable sheet and a method that allow for bleed printing about the entirety of an insert-defining perforation or the like.

It is another object of the present invention to provide a case insert printable sheet and a method that take advantage of standard size stock paper, especially United States standard legal size paper.

In accordance with the purposes of the invention as embodied and broadly described herein, a first aspect of the invention provides a case insert printable sheet have a peripheral edge and a defined pattern of reduced strength spaced inside the peripheral edge. The defined pattern has rectangular dimensions of about 7.25 inches (184.15 mm) by about 10.6875 (271.15 mm) inches to define an insert portion suitable for fitting a DVD case. The defined pattern is spaced apart from the peripheral edge to establish a margin (or border) portion between the defined pattern and the peripheral edge. The margin portion surrounds the insert portion and spaces the insert portion apart from the peripheral edge by a minimum distance of at least 0.5 inches.

In accordance with a second aspect of the invention, a method is provided for making a case insert. The method comprises providing a case insert printable sheet have a peripheral edge and a defined pattern of reduced strength spaced inside the peripheral edge. The defined pattern has rectangular dimensions of about 7.25 inches (184.15 mm) by about 10.6875 (271.15 mm) inches to define an insert portion suitable for a DVD case. The defined pattern is spaced apart from the peripheral edge to establish a margin (or border) portion between the defined pattern and the peripheral edge. The margin portion surrounds the insert portion and spaces the insert portion apart from the peripheral edge by a minimum distance of at least 0.5 inches.

### BRIEF DESCRIPTION OF THE DRAWINGS

The accompanying drawings are incorporated in and constitute a part of the specification. The drawings, together with the general description given above and the detailed description of the preferred embodiments and methods given below, serve to explain the principles of the invention. In such drawings:

FIG. 1 shows a case insert printable sheet according to an embodiment of the invention;

FIG. 2 shows a case insert printable sheet according to another embodiment of the invention; and

FIG. 3 shows a case inert made from the printable sheet of FIG. 1 or FIG. 2 applied to a DVD case.

### DETAILED DESCRIPTION OF PREFERRED EMBODIMENTS AND METHODS OF THE INVENTION

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” include plural referents unless the context clearly dictates otherwise.

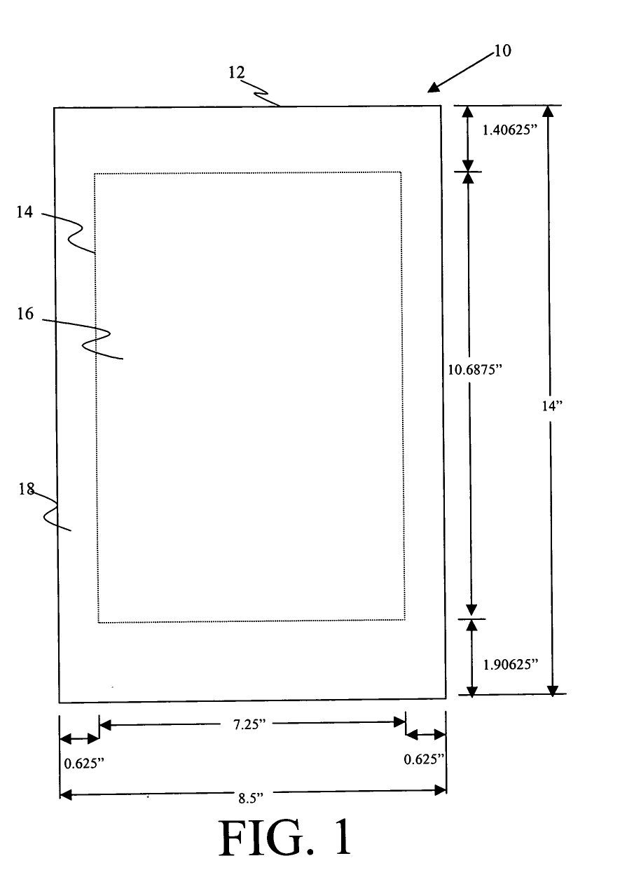

Referring now more particularly to the drawings, there is shown in FIG. 1 a case insert printable sheet generally designated by reference numeral 10. Generally, the sheet 10 may comprise paper, although other forms and materials of printable media having a sheet-like appearance may be used. The sheet 10 has a peripheral edge 12 in the shape of a rectangle. Situated within the peripheral edge 12 is defined pattern 14 of reduced strength. In the illustrated embodiment, the defined pattern 14 is shaped as a rectangle having the dimensions of a DVD case insert, i.e., about 7.25 inches (184.15 mm) by about 10 11/16 inches (271.15 mm). Inward of and defined by the pattern 14 is an insert portion 16. A margin or border portion 18 is situated between the defined pattern 14 and the peripheral edge 12, so that the border portion 18 surrounds the insert portion 16.

The defined pattern 14 preferably has sufficiently reduced strength to permit a user to successfully and cleanly separate the insert portion 16 from the border portion 18 by manual tearing, preferably without the use of cutting instruments such as scissors. On the other hand, the defined pattern 14 preferably has adequate strength to endure (without tearing) a printing cycle through a known printing device, such as an inkjet or laser printer. The defined pattern 14 of reduced strength preferably comprises a continuous perforation or the like. Techniques for forming perforations and the like in a sheet are well known in the art, e.g., a perforation die, and, therefore, are not described in further detail herein.

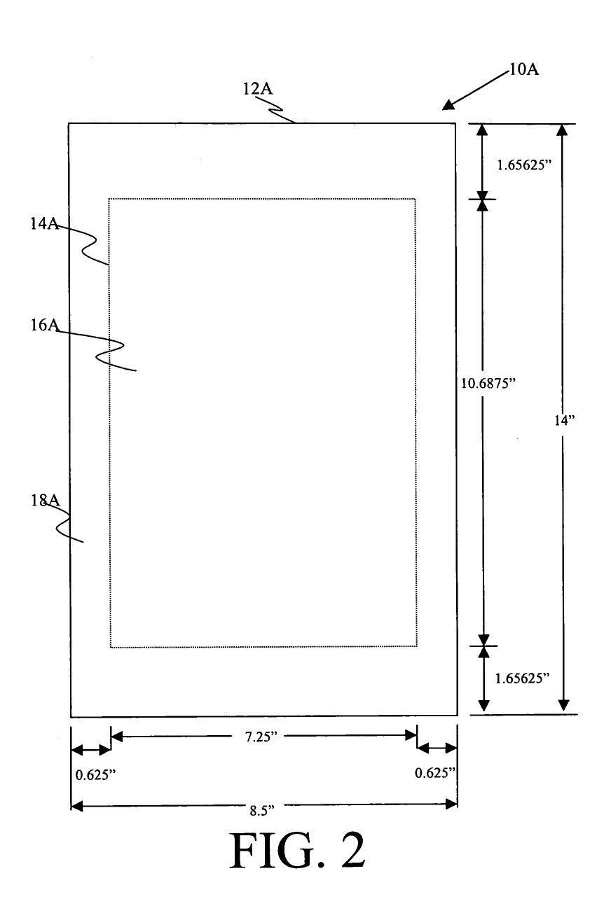

The size of the case insert printable sheet 10 is selected to permit the defined pattern 14 and insert portion 16 to be spaced apart from the peripheral edge 12 of the sheet 10 by a minimum distance of at least 0.5 inch (12.7 mm). In other words, the shortest distance between any part (or point) of the defined pattern 14 and any part (or point) of the peripheral edge 12 is no less than 0.5 inch (12.7 mm). Thus, the border portion 18 has a width of at least 0.5 inch (12.7 mm) continuously around the insert portion 16. More preferably, the minimum distance is about 0.625 inch (15.88 mm). Of note, the border portion 18 width may vary at different locations about the insert portion 16, so long as it remains above the minimum distance, as discussed in further detail below with regard to FIGS. 1 and 2. For example, the left and right margin portions optionally may be unequal to one another in dimension. Likewise, the top and bottom margin portions optionally may be unequal to one another in dimension.

According to an especially preferred embodiment of the invention, the case insert printable sheet 10 is standard legal size paper having dimensions of 8.5 inches (215.9 mm) by 14 inches (355.6 mm). In FIG. 1, the pattern 14 is centered between the sides of the sheet 10, providing a minimum distance of 0.625 inches (15.875 mm) between the sides of the pattern 14 and the corresponding sides of the periphery 12. The insert portion 16 is offset 0.5 inch (12.7 mm) from the bottom of sheet 10 to provide a gripper margin at the bottom of sheet 10. The pattern is centered vertically relative to the length of the sheet 10, minus the gripper portion, i.e., 14″−0.5″=13.5″. Thus, in FIG. 1 the width of the border portion 18 above and below the insert portion 16 is 1.40625 inches (38.26 mm) and 1.90625 inches (48.42 mm), respectively.

In FIG. 2, the pattern 14A is centered between the sides of the sheet 10A, providing a minimum distance of 0.625 inches (15.875 mm) between each sides of the pattern 14A and the corresponding sides of the periphery 12A. Unlike FIG. 1, however, a gripper margin portion is not provided in FIG. 2. The insert portion 16A is centered vertically relative to the length of the sheet 10A. Thus, in FIG. 2 the width of the border portion 18A above and below the insert portion 16A is 1.65625 inches (42.07 mm). Because the DVD insert portion 16A is centered on the sheet 10A, i.e., without the need for a gripper margin portion, the sheet 10A may be placed in a printer in either direction—top first or bottom first—without causing misprint problems.

A method for making and using a DVD case insert will now be described in further detail. The method comprises providing a case insert printable sheet as embodied herein. Informational and/or decorative information is printed onto the sheet using a suitable printing device, such as an ink jet printer or a laser printer. Printing may be performed using appropriate commercially available software. Many major software programs, including Microsoft Word, are compatible with and pre-programmed for print selecting the United States Legal Size (8½″×14″) format. Further, the Legal Size format is compatible with paper feed trays found in may laser and inkjet printers sold in the United States. For these and other reasons (e.g., full bleed capability) discussed herein, Legal Size paper is preferred in practicing this embodiment of the invention.

Printing preferably comprises a selective positioning step for placing the image (e.g., information and/or decoration) to be printed in the defined pattern. It is highly desirable to bleed the image over the defined pattern and into the margin portion in order to reduce or eliminate the unprinted areas along the edge or edges of the insert portion. These unprinted areas are typically white, although the particular color will depend on the color of the selected printable sheet. The image may be bled over a segment (i.e., the left side, right side, top edge, and bottom edge) of the defined pattern, or a combination or all segments of the defined pattern. In the case that bleed over is desired, the printed image is preferably larger in dimension than the insert portion. Alternatively, the printed image may be sized equal to the insert portion dimensions, although doing so will place greater importance upon the selective positioning step to avoid the formation of unprinted areas along the edge or edges of the insert portion.

After printing, the border portion is separated from the insert portion of the case insert printable sheet. Bleed printed images are effectively cropped. Further, the border areas are sufficient in size to facilitate ease of their removal, e.g., by grabbing with one's fingers and ripping from the insert portion.

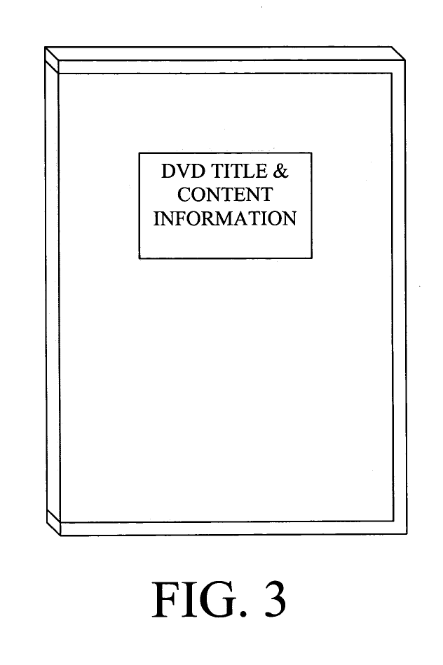

FIG. 3 shows an insert 10, 10A of the present invention applied to a DVD case 20. The insert portion 10, 10A is applied or otherwise joined to the DVD case 20. The insert portion 10, 10A is turned sideways from the orientation shown in FIGS. 1 and 2, so that the 7.25″ width of the insert portion 10, 10A extends height-wise relative to the 7.5″ height of the case 20 of FIG. 3. The insert 10, 10A is folded around the spine of the DVD case 20 to cover substantially all of the front and rear faces of the DVD case 20. In an especially preferred embodiment, the DVD case 20 is provided with an outer transparent cover having an opening for receiving the case insert. Alternatively, the case insert 10, 10A may be adhered or laminated to the case 20. In this regard, in a modified embodiment of the invention the case insert printable sheet may comprise a label having an adhesive rear and a peel-away backing temporarily and removably attached to the adhesive rear.

From the above, it will become apparent that embodiments of the invention as described herein may provide one or more of the following advantages.

First, the use of standard United States Legal Size 8½″×14″ paper format makes certain embodiment of the invention particularly compatible with various commercially available software programs and printers.

Second, embodiments of the invention are particularly easy to use for both the professional art designer as well as the layperson in designing Full Bleed DVD case inserts. Using vector-based art layout programs such as Adobe Illustrator or Corel Draw, the photo or graphic image may be “floated” around the sheet until the best position is found. The image may then be pasted using the bleed area to its best advantage. All four sides may bleed off the edge with equal ease without problems caused by inadequate bleed area.

Third, the relatively large size of the border portions of embodiments of the invention facilitates processing. For example, it is generally easier to grip, e.g., with fingers, the border portions of embodiments of the invention for tearing along the defined pattern of reduced strength and for discarding border portion waste.

Another advantage particularly applicable to embodiments selecting the United States Legal Size paper format relates to storage and filing. Many folders, cabinets, boxes, and cartons are specifically designed for holding legal size documents.

Certain embodiments of the invention which make use of United States Legal Size paper format are especially advantageous when used in the context of custom printing processes. Custom printing of DVD inserts often involves commercial offset printing a company's logo and contact information on a blank sheet, then adding photos, graphics, and/or program or data information at a later date by running the sheet through a computer printer. Commercial offset printing is typically performed in presses set up in advance to handle either United States Letter Size paper format or United States Legal Size paper format to expedite processing. A relatively small number, if any, printers in the United States remains set up in the normal course of operation for handling A4 paper. There is a cost involved with resetting a press to handle a size such as A4. There is also an issue of A4 paper availability. These costs and issues are avoided when using United States Legal Size paper format.

Additional advantages and modifications will readily occur to those skilled in the art upon reference to this disclosure. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

1. A case insert printable sheet have a peripheral edge and a defined pattern of reduced strength spaced inside the peripheral edge, the defined pattern having rectangular dimensions of about 7.25 inches by about 10.6875 inches to define an insert portion suitable for fitting an industry standard DVD case, the defined pattern being spaced apart from the peripheral edge to establish a margin portion between the defined pattern and the peripheral edge, the margin portion surrounding the insert portion and spacing the insert portion apart from the peripheral edge by a minimum margin distance of at least 0.5 inches.

2. A case insert printable sheet according to claim 1, wherein the stock sheet is formed of paper.

3. A case insert printable sheet according to claim 1, wherein the defined pattern comprises perforations.

4. A case insert printable sheet according to claim 1, wherein the peripheral edge of the stock sheet has rectangular dimensions of about 8.5 inches by about 14 inches.

5. A case insert printable sheet according to claim 1, wherein:
the peripheral edge comprises a top, a bottom, and opposite sides;
the insert portion is positioned equidistant from each of the opposite sides of the peripheral edge; and
the insert portion is positioned equidistant from the top and bottom of the peripheral edge.

6. A case insert printable sheet according to claim 1, wherein the margin portion spaces the insert portion apart from the peripheral edge by a minimum distance of at least 0.625 inch.

7. A case insert printable sheet according to claim 6, wherein the peripheral edge of the sheet has rectangular dimensions of about 8.5 inches by about 14 inches.

8. A case insert printable sheet according to claim 7, wherein:
the peripheral edge comprises a top, a bottom, and opposite sides;
the insert portion is positioned equidistant from each of the opposite sides of the peripheral edge; and
the insert portion is positioned equidistant from the top and bottom of the peripheral edge.

9. A case insert printable sheet according to claim 1, further comprising an image printed on the case insert printable sheet, wherein the image bleeds over a segment of the defined pattern into the margin portion.

10. A case insert printable sheet according to claim 1, further comprising an image printed on the case insert printable sheet, wherein the image bleeds over all of the defined pattern into the margin portion.

11-20. (canceled)

21. A case insert printable sheet have a peripheral edge and a defined pattern of reduced strength spaced inside the peripheral edge, the defined pattern having rectangular dimensions of an industry standard DVD case to define an insert, the defined pattern being spaced apart from the peripheral edge to establish a margin portion between the defined pattern and the peripheral edge, the margin portion surrounding the insert portion and spacing the insert portion apart from the peripheral edge by a minimum margin distance of at least 0.5 inches, wherein the peripheral edge of the sheet has rectangular dimensions of about 8.5 inches by about 14 inches.
